(19) United States
(12) Patent Application Publication
(10) Pub. No.: US 2022/0245533 A1
(43) Pub. Date: Aug. 4, 2022

(54) METHOD AND SYSTEM FOR COMBINATORIAL OPTIMIZATION OF VEHICLE ROUTING USING A SIMULATED ANNEALING ON A UNIVERSAL OPTIMIZATION PROCESSOR

(71) Applicant: QPIAI INDIA PRIVATE LIMITED, BANGALORE (IN)

(72) Inventors: Aswanth Krishnan, Palakkad (IN); Lakshya Priyadarshi, Lucknow (IN); Arun Sehrawat, Panipat (IN); Nagendra Nagaraja, Bangalore (IN)

(21) Appl. No.: 17/665,463

(22) Filed: Apr. 11, 2022

(30) Foreign Application Priority Data
Feb. 4, 2021 (IN) 202141000239

(51) Int. Cl. G06Q 10/04; G06Q 50/30; G06Q 10/06

(52) U.S. Cl. CPC G06Q 10/047; G06Q 10/06312; G06Q 50/30

(57) ABSTRACT

The embodiments herein disclose a system and method for combinatorial optimization of vehicle routing using simulated annealing on a universal optimization processor. The system characterizes the transport request from a supplier to a customer with its pickup location and delivery location respectively and also records the load volume for the corresponding request. The transport requests are received as an input and the system optimizes route plans for the collection of transport requests based on a simulated annealing. The system defines a route as valid if and only if (when) pickup location precedes the delivery location in route enumeration. Each vehicle is characterized by its maximum capacity value, such that a total volume of loads transported by a vehicle for a given set of delivery services cannot exceed its maximum capacity value. The system generates near-optimal route plan and total distance travelled based on a simulated annealing metaheuristic.

### CROSS-REFERENCE TO RELATED APPLICATIONS

The embodiments herein claim the priority of the Indian Provisional Patent Application numbered IN 202141000239 filed on Jan. 4, 2021, with the title “METHOD AND APPARATUS FOR COMBINATORIAL OPTIMIZATION OF VEHICLE ROUTING USING A SIMULATED ANNEALING ON A UNIVERSAL OPTIMIZATION PROCESSOR”, and the contents of which are included entirely as reference herein.

### BACKGROUND

### Technical Field

The embodiments herein are generally related to a field of pick-up and delivery routing systems. The embodiments herein are more particularly related to method and system for combinatorial optimization of vehicle routing using a simulated annealing on a universal optimization processor.

### Description of the Related Art

Typically, conventional pick-up and drop service systems a number of vehicles are required to perform a number of delivery services, each characterized by its own pickup point, delivery point, and a corresponding load volume that needs to be transported from the pickup point to the delivery point. Most of the conventional pick-up and drop service systems generate an optimized route plan that covers all pickup and delivery points such that distance traveled is near-optimal using specialized algorithm running on a universal optimization processor.

However, the conventional pick up and drop service systems do not efficiently manage distances travelled for serving customer requests and also lack techniques to minimize overall distribution costs, total time, and fuel consumption. Also, the conventional pick-up and drop service systems are not typically equipped to handle more customer requests without upfront investment in the vehicle fleet or increasing number of dispatchers and also do not include any reliable decision- support systems for pickup and delivery vehicle routing with quantitative information.

Hence there is need for a method and a system for optimization of vehicle routing that satisfactorily addresses the above-mentioned issues.

The above-mentioned shortcomings, disadvantages and problems are addressed herein, and which will be understood by reading and studying the following specification.

### OBJECT OF THE EMBODIMENTS HEREIN

The primary object of the embodiments herein is to provide a method and system for combinatorial optimization of vehicle routing using a simulated annealing on a universal optimization processor.

Another object of the embodiments herein is to provide a method and a system for producing an optimal route plan for pickup and delivery services.

Yet another object of the embodiments herein is to provide a method and a system to achieve a reduction in the distance traveled for serving customer requests and thereby reduce overall distribution costs, total time, and fuel consumption.

Yet another object of the embodiments herein is to provide a method and a system to handle more customer requests without upfront investment in the vehicle fleet, and fleet management is made efficient with a reduced number of dispatchers.

Yet another object of the embodiments herein is to provide a method and a system that facilitates a reliable decision-support system for pickup and delivery vehicle routing with quantitative information.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system and a method for combinatorial optimization more particularly to logistics optimization to optimize the vehicle route planning for a set of pickup and delivery requests. The embodiments herein disclose applications in supplier-to-customer delivery, inbound and outbound deliveries by manufacturing plants and warehouses, and logistics operations which support pickup and delivery services.

According to an embodiment herein a method for combinatorial optimization of vehicle routing using simulated annealing on a universal optimization processor is disclosed. The method includes receiving a set of transport requests from a supplier to a customer defined by pickup and delivery points and the corresponding load volumes needed to be transported from pickup to delivery points. The method also includes identifying pickup and delivery points by their respective geographical locations as defined by their latitude and longitude coordinates. The method further includes computing the distance matrix for all the locations in the given set of transport requests. The method further includes characterizing the transport request from a supplier to a customer with its pickup location and delivery location respectively and also records the load volume for the corresponding request. The transport request is received as an input and the route plans are optimized for the collection of transport requests based on a simulated annealing. The method further includes defining a route as valid if and only if pickup location precedes the delivery location in route enumeration. Each vehicle is characterized by its maximum capacity value, such that a total volume of loads transported by a vehicle for a given set of delivery services does not exceed its maximum capacity value. The method generates near-optimal route plan Sₐₚₚ and the total distance travelled d(Sₐₚₚ) based on a simulated annealing metaheuristic algorithm.

According to one embodiment herein, the characterizing the transport request is achieved by generating a random tour S. The random tour S is the element of solution space S (S∈S). The solution space S is the set of feasible or possible valid route plans. Further, the near-optimal route plan Sₐₚₚ is set to random tour S (Sₐₚₚ=S) and total distance travelled d(Sₐₚₚ) to total distance d(S) travelled by all the vehicles V in the random tour S (d(Sₐₚₚ)=d(S)) and T=Tᵢₙ. Furthermore, from the random tour S a new state S′ is generated by a rule: a) Move a random customer from one vehicle to another randomly chosen vehicle and b) Assign the state S to new state S′ according to S:=S′.

Besides, the method generates near-optimal route plan Sₐₚₚ and total distance travelled d(Sₐₚₚ) as output for the given set of transport request based on simulated annealing metaheuristic algorithm, provided that the method meets precedence and capacity constraints. The precedence constraint is defined as the order of pickup location must precede the delivery location in route enumeration. The capacity constraint of a vehicle is defined as the total volume of load transported by a vehicle for a given set of delivery services does not exceed the vehicle maximum capacity.

According to one embodiment herein, the transport request as input is either static or dynamic. The dynamically changing input includes deletion of pickup and delivery locations or addition of pickup and delivery locations towards the existing set of pickup and delivery locations. The deletion of pickup and delivery locations is achieved by finding a vehicle V assigned to a customer who wants to delete the transport request. Delete the corresponding pickup and delivery locations of the vehicle V and then re-route the existing pickup and delivery locations using the simulated annealing metaheuristic algorithm. Similarly, addition of pickup and delivery location to the existing set of pickup and delivery locations is achieved by adding a new transport request of addition to the existing set of pickup and delivery locations and then applying simulated annealing metaheuristic algorithm.

According to one embodiment herein, the system for combinatorial optimization of vehicle routing using simulated annealing on a universal optimization processor is disclosed. The system includes plurality of modules such as a transport request collection module, a transport route determination module, and a route plan response module. The transport request collection module is configured to capture plurality of data such as transport request from a supplier to a customer, load volume, pickup and delivery locations and routes the captured plurality of data to the transport route determination module. The transport route determination module of the system is configured to receive the plurality of captured data from the transport request collection module. The transport route determination module further includes one or more modules such as a geographical index computation module, route plan generator module, route optimization module, route constraint evaluator module and a vehicle constraint evaluator module. The geographical index computation module provided in the transport route determination module is configured to identify the pickup and the delivery locations as per corresponding geographical locations of the transport request and to compute distance matrix for all the geographical locations in the given set of transport request. The geographical locations include respective latitude and longitude co-ordinates of the pickup and delivery points. Further, the route plan generator module provided in the transport route determination module is configured to generate all possible routes for the given set of transport requests. Then, the route optimization module of the transport route determination module optimizes the route plans for the collection of routes generated by the route plan generator module based on simulated annealing metaheuristic algorithm. Furthermore, a route constraint evaluator module and a vehicle constraint evaluator module provided in the transport route determination module evaluate the precedence constraint and capacity constraint, respectively. The precedence constraint is defined as that the order of pickup location precedes the delivery location in route enumeration. The capacity constraint of a vehicle is defined as the total volume of load transported by a vehicle for a given set of delivery services does not exceed the vehicle maximum capacity. Finally, a route plan response module is configured to receive the optimized route plan for the set of transport request from the transport route determination module, to provide near-optimal route plan and total distance travelled by the vehicle based on simulated annealing metaheuristic algorithm. The near-optimal route plan provided by the route plan response module meets both the precedence and capacity constraints.

Therefore, the embodiments herein provide system and method that facilitate achieving an optimal route plan for pickup and delivery services. By achieving the optimization, the system and method of the embodiments herein enable achieving a reduction in the distance traveled for serving customer requests. The reduction in distance traveled results in reduction of overall distribution costs, total time, and fuel consumption. The system and the method of the embodiments herein enables handling of more customer requests without upfront investment in the vehicle fleet when compared to conventional systems. Furthermore, the embodiments herein also render the fleet management to be more efficient with a reduced number of dispatchers when compared to conventional systems. Besides, the embodiments herein provides result in a reliable decision-support system for pickup and delivery vehicle routing with quantitative information.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features, and advantages will occur to those skilled in the art from the following description of the preferred embodiment and the accompanying drawings in which:

FIG. 1A-1B jointly illustrate a flow chart explaining a method for combinatorial optimization of vehicle routing using a simulated annealing on a universal optimization processor, according to an embodiment herein.

FIG. 1C illustrates a flow chart explaining a method for dynamically changing input points such as addition and deletion of pickup and drop locations, according to an embodiment herein.

FIG. 2A illustrates a flow chart explaining a process of generating a feasible solution, according to an embodiment herein.

FIG. 2B illustrates a flow chart explaining a process of generating a new state, according to an embodiment herein.

FIG. 3 illustrates a functional block diagram of a system for a combinatorial optimization of vehicle routing using a simulated annealing on a universal optimization processor, according to an embodiment herein.

FIG. 4 illustrates a schematic map indicating pick-up and delivery pairs, in an exemplary scenario, according to an embodiment herein.

FIG. 5A illustrates a screenshot of addition of input transportation request and setting hyperparameters, according to an embodiment herein.

FIG. 5B illustrates a screenshot of real-time optimization process, according to an embodiment herein.

FIG. 5C illustrates a screenshot of optimal routes, geospatial visualization, and tabulated route plans, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

The detailed description of various exemplary embodiments of the disclosure is described herein with reference to the accompanying drawings. It should be noted that the embodiments are described herein in such details as to clearly communicate the disclosure. However, the amount/number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however that it is not intended to limit the disclosure to the forms disclosed, but on the contrary, the disclosure is to cover all modifications, equivalents, and alternatives falling within the scope of the disclosure.

The various embodiments herein provide a system and a method for combinatorial optimization more particularly to logistics optimization to optimize the vehicle route planning for a set of pickup and delivery requests. The embodiments herein disclose applications in supplier-to-customer delivery, inbound and outbound deliveries by manufacturing plants and warehouses, and logistics operations which support pickup and delivery services.

According to an embodiment herein, a method for combinatorial optimization of vehicle routing using simulated annealing on a universal optimization processor is disclosed. The method includes receiving a set of transport requests from a supplier to a customer defined by pickup and delivery points and the corresponding load volumes needed to be transported from pickup to delivery points. The method also includes identifying pickup and delivery points by their respective geographical locations as defined by their latitude and longitude coordinates. The method further includes computing the distance matrix for all the locations in the given set of transport requests. The method further includes characterizing the transport request from a supplier to a customer with its pickup location and delivery location respectively and also records the load volume for the corresponding request. The transport request is received as an input and the route plans are optimized for the collection of transport requests based on a simulated annealing. The method further includes defining a route as valid if and only if pickup location precedes the delivery location in route enumeration. Each vehicle is characterized by its maximum capacity value, such that a total volume of loads transported by a vehicle for a given set of delivery services does not exceed its maximum capacity value. The method generates near-optimal route plan Sₐₚₚ and the total distance travelled d(Sₐₚₚ) based on a simulated annealing metaheuristic algorithm.

According to one embodiment herein, the characterizing the transport request is achieved by generating a random tour S. The random tour S is the element of solution space S (S∈S). The solution space S is the set of feasible or possible valid route plans. Further, the near-optimal route plan Sₐₚₚ is set to random tour S (Sₐₚₚ=S) and total distance travelled d(Sₐₚₚ) to total distance d(S) travelled by all the vehicles V in the random tour S (d(Sₐₚₚ)=d(S)) and T=Tᵢₙ. Furthermore, from the random tour S, a new state S′ is generated by a rule: a) Move a random customer from one vehicle to another randomly chosen vehicle and b) Assign the state S to new state S′ according to S:=S′. Besides, the method generates near-optimal route plan Sₐₚₚ and total distance travelled d(Sₐₚₚ) as output for the given set of transport request based on simulated annealing metaheuristic algorithm, when the method meets precedence and capacity constraints. The precedence constraint is defined as such (that) the order of pickup location precedes the delivery location in route enumeration. The capacity constraint of a vehicle is defined as such (that) the total volume of load transported by a vehicle for a given set of delivery services does not exceed the vehicle maximum capacity.

According to one embodiment herein, the transport request as input is either static or dynamic. The dynamically changing input includes deletion of pickup and delivery locations or addition of pickup and delivery locations towards the existing set of pickup and delivery locations. The deletion of pickup and delivery locations is achieved by finding a vehicle V assigned to a customer who wants to delete the transport request. Delete the corresponding pickup and delivery locations of the vehicle V and then re-route the existing pickup and delivery locations using the simulated annealing metaheuristic algorithm. Similarly, addition of pickup and delivery location to the existing set of pickup and delivery locations is achieved by adding a new transport request of addition to the existing set of pickup and delivery locations and then applying simulated annealing metaheuristic algorithm.

According to one embodiment herein, the system for combinatorial optimization of vehicle routing using simulated annealing on a universal optimization processor is disclosed. The system includes plurality of modules such as a transport request collection module, a transport route determination module, and a route plan response module. The transport request collection module is configured to capture plurality of data such as transport request from a supplier to a customer, load volume, pickup and delivery locations and routes the captured plurality of data to the transport route determination module. The transport route determination module of the system is configured to receive the plurality of captured data from the transport request collection module. The transport route determination module further includes one or more modules such as a geographical index computation module, route plan generator module, route optimization module, route constraint evaluator module and a vehicle constraint evaluator module. The geographical index computation module provided in the transport route determination module is configured to identify the pickup and the delivery locations as per corresponding geographical locations of the transport request and to compute distance matrix for all the geographical locations in the given set of transport request. The geographical locations include respective latitude and longitude co-ordinates of the pickup and delivery points. Further, the route plan generator module provided in the transport route determination module is configured to generate all possible routes for the given set of transport requests. Then, the route optimization module of the transport route determination module optimizes the route plans for the collection of routes generated by the route plan generator module based on simulated annealing metaheuristic algorithm. Furthermore, a route constraint evaluator module and a vehicle constraint evaluator module provided in the transport route determination module evaluates the precedence constraint and capacity constraint, respectively. The precedence constraint is defined as such that the order of pickup location does precede the delivery location in route enumeration. The capacity constraint of a vehicle is defined as such that the total volume of load transported by a vehicle for a given set of delivery services does not exceed the vehicle maximum capacity. Finally, a route plan response module configured to receive the optimized route plan for the set of transport request from the transport route determination module, provides near-optimal route plan and total distance travelled by the vehicle based on simulated annealing metaheuristic algorithm. The near-optimal route plan provided by the route plan response module meets both the precedence and capacity constraints.

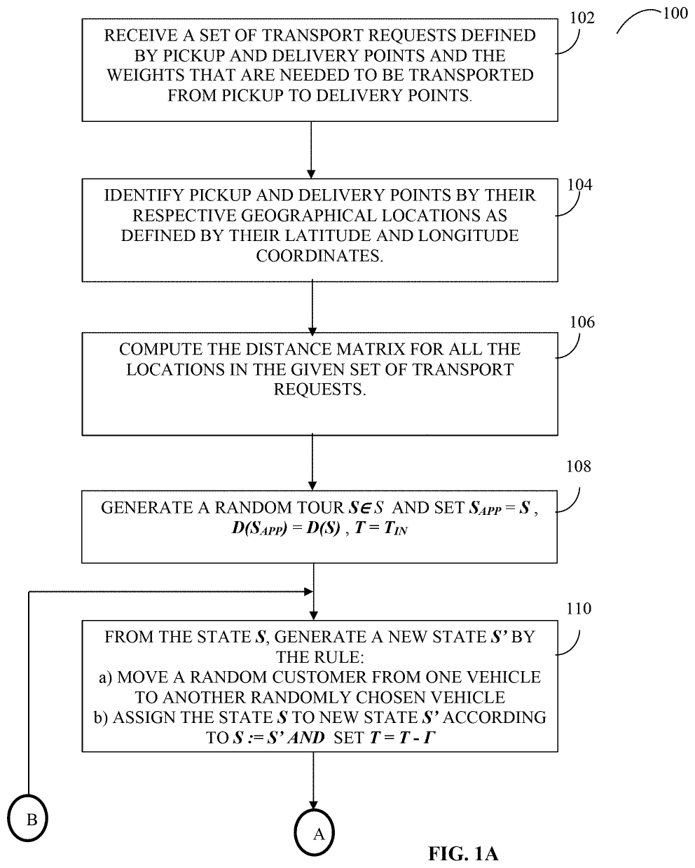

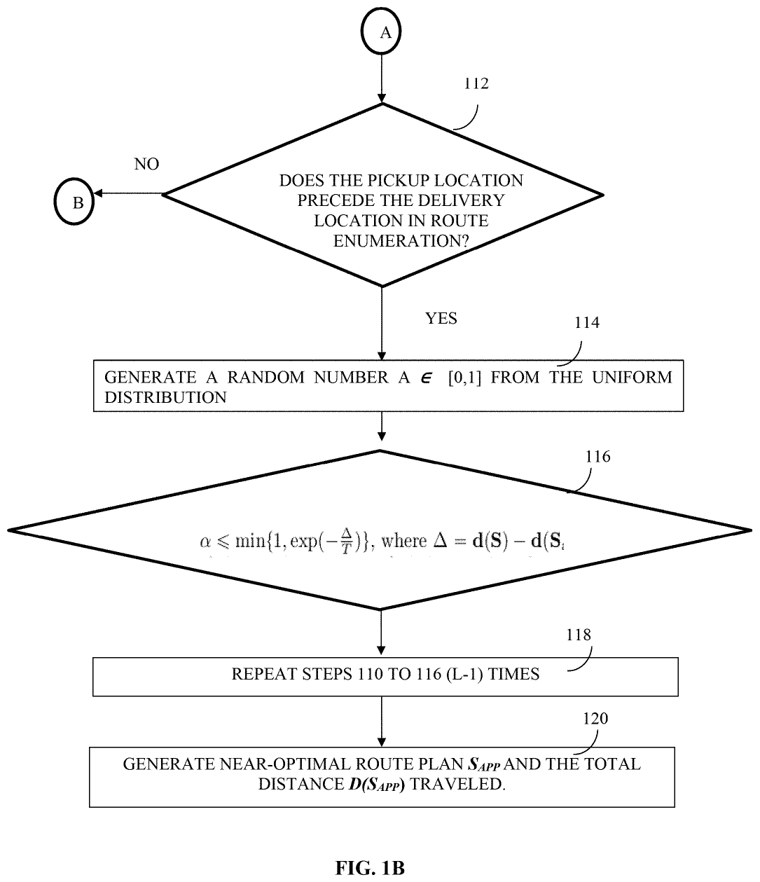

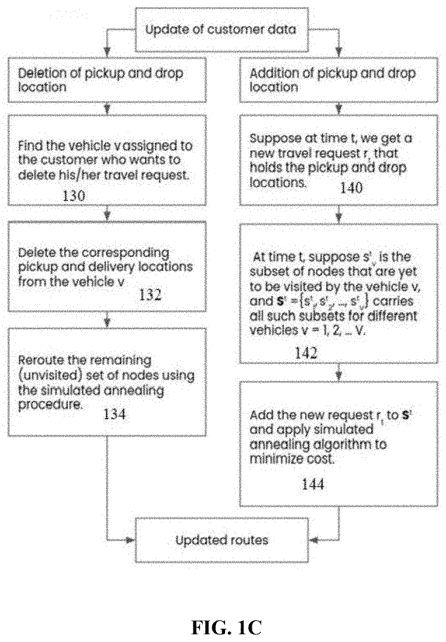

FIG. 1A-1B jointly illustrate a flow chart explaining a method for combinatorial optimization of vehicle routing using a simulated annealing on a universal optimization processor, according to an embodiment herein. According to an embodiment herein, the method 100 of the embodiments herein receives a set of transport requests defined by pickup and delivery points and the weights that are needed to be transported from pickup to delivery points as inputs 102. The output the method 100 generates is the near-optimal route plan Sₐₚₚ and the total distance d(Sₐₚₚ) traveled 120. The pickup and delivery points are identified by their respective geographical locations as defined by their latitude and longitude coordinates 104. With this information the distance matrix for all the locations in the given set of transport requests is computed 106. The system is based on a simulated annealing metaheuristic. The hyperparameters to the metaheuristic are the number of iterations I, initial annealing temperature Tin, and the final annealing temperature Tf. Furthermore, at step 108, the characterization of transport request is carried out by generating a random tour S∈S and set Sₐₚₚ=S, such that d(Sₐₚₚ)=d(S), T=Tin. Followed by, at step 110, from the state S, a new state S′ is generated by the rule: a) Move a random customer from one vehicle to another randomly chosen vehicle and b) Assign the state S to new state S′ according to S:=S′. Further, at step 112, the precedence constraint of the route (for state S) is evaluated by verifying if the order of pickup location and delivery location is such that pickup location precedes the delivery location in route enumeration. Correspondingly, it is determined if each vehicle is characterized by its maximum capacity value. The total volume of loads transported by a vehicle for a given set of delivery services does not exceeds its maximum capacity value. This condition is defined as the capacity constraint on a vehicle. Finally, the near-optimal route plan Sₐₚₚ and the total distance d(Sₐₚₚ) traveled 120 is generated as the output.

FIG. 1C illustrates a flow chart explaining a method for dynamically changing input points such as addition and deletion of pickup and drop locations, according to an embodiment herein. According to an embodiment herein, the method 100 receives transport request, which can be either static or dynamically changing. The dynamically changing transport request includes either deletion or addition of pickup and delivery locations. FIG. 1C illustrates both deletion and addition of pickup and delivery locations in the existing set of pickup and delivery locations. At step 130, to delete a pickup and deliver location, find a vehicle V assigned to a customer, who wants to delete the transport request. Delete the corresponding pickup and delivery location from the vehicle V 132. Finally at step 134, re-route the existing pickup and delivery locations using simulated annealing metaheuristic algorithm. Similarly, while addition of pickup and delivery location, a new transport request is added to the existing set of pickup and delivery locations and then simulated annealing metaheuristic algorithm is applied.

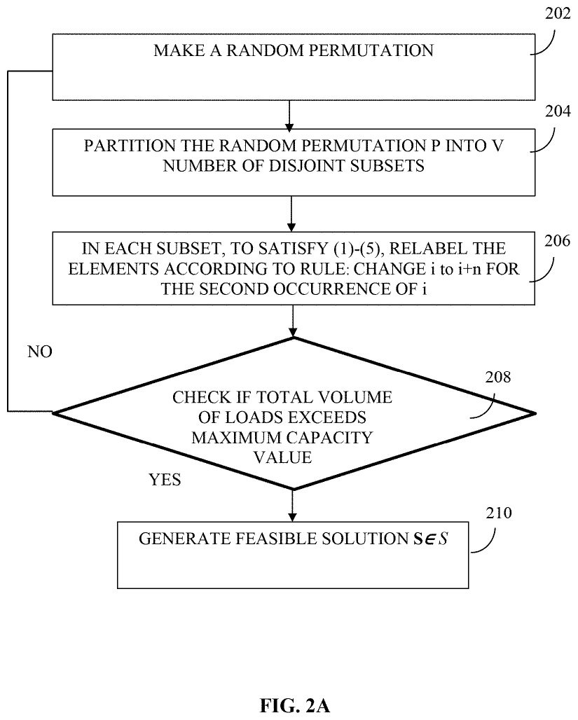

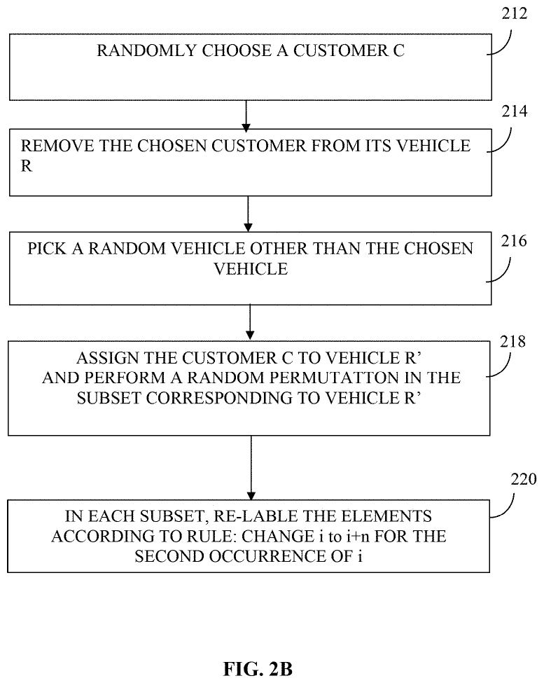

FIG. 2A illustrates a flow chart explaining a process of generating a feasible solution, according to an embodiment herein. At step 202, a random permutation P={1, 2, . . . , n} is performed. At step 204, the random permutation P is partitioned into V number of disjoint subsets. Every element is duplicated within each subset. A random permutation of elements is performed in each subset. At step 206, in each subset, the elements are re-labelled according to rule: Change i to i+n for the second occurrence of i. Further, at step 208, the satisfiability of the capacity constraints is verified. If capacity constraints are satisfied, a feasible solution S∈S is generated at step 210. If capacity constraints are not satisfied, repeat steps 202-208.

FIG. 2B illustrates a flow chart explaining a process of generating a new state, according to an embodiment herein. At step 212, a customer C is randomly chosen. At step 214, the chosen customer C is removed from the vehicle R. At 216, a random vehicle R′ different from R is chosen. At step 218, the customer C is assigned to vehicle R′ and a random permutation is performed in the subset corresponding to the vehicle R′. At step 220, in each subset if satisfy the steps (212)-(218) the elements are re-labelled according to the rule: change i to i+n for the second occurrence of i. Further in order to accelerate the computation, the entire algorithm is mapped specialized optimizer chip to map different parts of optimization algorithm.

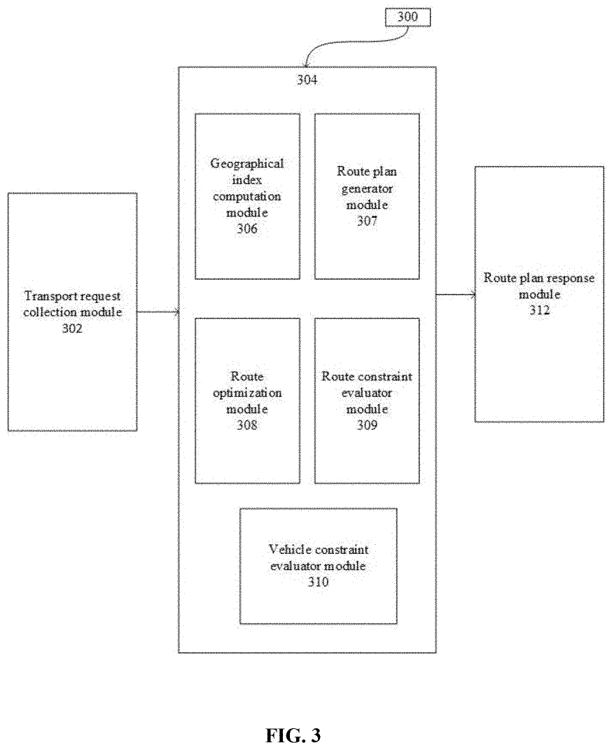

FIG. 3 illustrates a functional block diagram of a system for a combinatorial optimization of vehicle routing using a simulated annealing on a universal optimization processor, according to an embodiment herein. With regard to FIG. 3 illustrates a system 300 for combinatorial optimization of vehicle routing using a simulated annealing on a universal optimization processor. The system includes plurality of modules such as a transport request collection module 302, a transport route determination module 304 and a route plan response module 312. The transport request collection module 302 is configured to capture plurality of data such as transport request from a supplier to a customer, load volume, pickup and delivery locations and routes the captured plurality of data to the transport route determination module 304. The transport route determination module 304 of the system is configured to receive the plurality of captured data from the transport request collection module 302. The transport route determination module 304 further includes one or more modules such as a geographical index computation module 306, route plan generator module 307, route optimization module 308. route constraint evaluator module 309 and a vehicle constraint evaluator module 310. The geographical index computation module 306 provided in the transport route determination module 304 is configured to identify the pickup and the delivery locations as per corresponding geographical locations of the transport request and to compute distance matrix for all the geographical locations in the given set of transport request. The geographical locations include respective latitude and longitude co-ordinates of the pickup and delivery points. Further, the route plan generator module 307 provided in the transport route determination module 304 is configured to generate all possible routes for the given set of transport requests. Then, the route optimization module 308 of the transport route determination module 304 optimizes the route plans for the collection of routes generated by the route plan generator module 307 based on simulated annealing metaheuristic algorithm. Furthermore, a route constraint evaluator module 309 and a vehicle constraint evaluator module 310 provided in the transport route determination module 304 evaluates the precedence constraint and capacity constraint, respectively. The precedence constraint is defined as the order of pickup location does precede the delivery location in route enumeration. The capacity constraint of a vehicle is defined such that the total volume of load transported by a vehicle for a given set of delivery services should not exceed the vehicle maximum capacity. Finally, a route plan response module 312 configured to receive the optimized route plan for the set of transport request from the transport route determination module 304, provides near-optimal route plan and total distance travelled by the vehicle based on simulated annealing metaheuristic algorithm. The near-optimal route plan provided by the route plan response module meets both the precedence and capacity constraints.

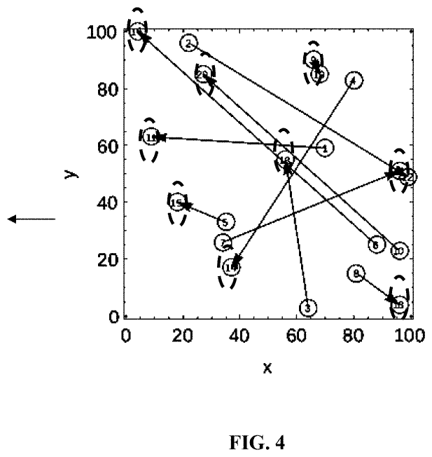

FIG. 4 illustrates a schematic map indicating pick-up and delivery pairs, in an exemplary scenario, according to an embodiment herein. In the schematic map 400 of FIG. 4, for an example of n=10 transport requests, pick-up (indicated as circles) and delivery (indicated as dotted circles) pairs are illustrated through arrows, plotted along the graph.

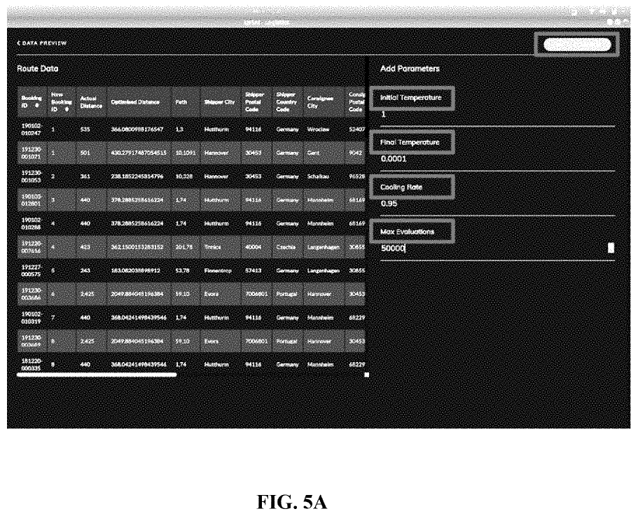

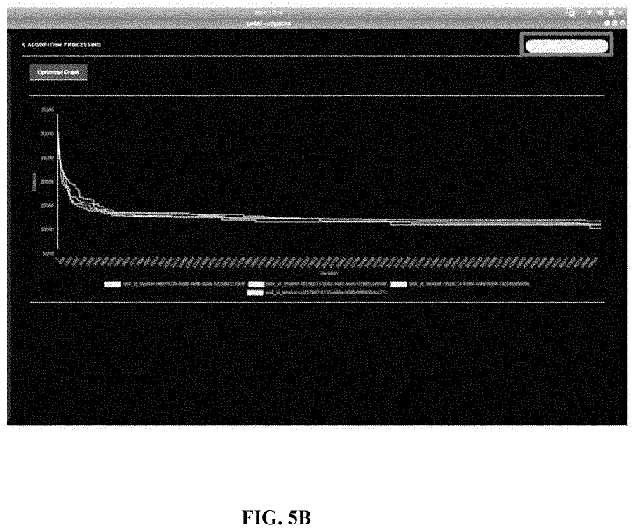

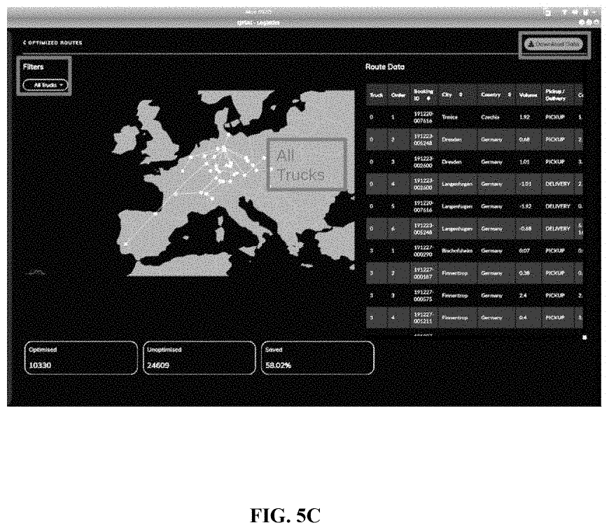

FIG. 5A illustrates a screenshot of addition of input transportation request and setting hyperparameters, according to an embodiment herein. The screen shot illustrates the real-time addition of transport request as input and setting the hyperparameters.

FIG. 5B illustrates a screenshot of real-time optimization process, according to an embodiment herein. The screenshot illustrates the real-time optimization of route plan in progress and thereby cost reduction.

FIG. 5C illustrates a screenshot of optimal routes, geospatial visualization, and tabulated route plans, according to an embodiment herein. The screenshot illustrates the optimal route plan generated in real-time and the associated geospatial visualization and tabulated routing data.

The embodiments herein may be more clearly understood with reference to the following example which are given by way of illustration only. One has to consider that the following examples are included to demonstrate certain non-limiting aspects of the embodiments disclosed herein. It should be appreciated by those of skill in the art that the techniques disclosed in the examples which follow represent techniques discovered by the inventor to function well in the practice of the embodiments disclosed herein. However, those of skilled in the art should, in light of the present disclosure, appreciate that many changes can be made in the specific embodiments which are disclosed and still obtain a like or similar result without departing from the spirit and scope of the embodiments disclosed herein.

### EXAMPLE 1

Consider, for example for n customers, n transport requests (where n is a whole number) are provided as input to the system such that n pickup locations are mapped to n delivery locations. The index of customer and their corresponding pickup location is the same and is denoted by i. The customer i requests to transfer a load volume wi from pickup location i to its corresponding delivery location. We label the n pickup locations as an enumeration mapped to the sequence 1, 2, . . . upto n and corresponding delivery locations mapped to the sequence 1+n, 2+n, . . . , 2n. We denote the set of pickup locations by a set P:={1,2 . . . n} and the set of delivery locations by a set D:={1+n, 2+n, . . . , 2n}. Thus, the set of all pickup and delivery locations is denoted by a set N:=P∪D.

All the locations in the set N are connected and the distance between each pair of these locations is characterized by a non-negative value dᵢⱼ corresponding to locations i and j. To perform the delivery services, V vehicles are available. All the n customer requests will be served by creating V tours across the 2ₙ locations in N such that each vehicle performs one tour, and the capacity and precedence constraints are satisfied for each vehicle and each route respectively.

A tour for kth vehicle is specified by an ordered set

$${S}_{k} = \{ {i}_{1} , {i}_{2} , … {i}_{r} \} ⊆ N such that \qquad ( 1 )$$

$$if {i}_{t} ∈ P then {i}_{t} + n = {i}_{{t}^{′}} , where t < {t}^{′} ⩽ τ , \qquad ( 2 )$$

$${S}_{k} ⋂ {S}_{{k}^{′}} = ∅ for all k \neq {k}^{′} , and \qquad ( 3 )$$

$${{⋃}_{k = 1}}^{V} {S}_{k} = N . \qquad ( 4 )$$

For the vehicle k, we define a tour (1) as an ordered set Sk. The set Sk specifies the order of visit across the locations i1, i2, . . . , iT. Equation (2) enforces the condition that a pickup location and its corresponding delivery location will be visited by the same vehicle and the precedence constraint is satisfied. The vehicle k visits τ locations on a tour and we represent the sequence 1, 2, . . . τ as a series of τ time steps. Equation (3) enforces the constraint that all the locations visited by a vehicle are exclusive to that vehicle only, and two different vehicles do not share any common node (pickup location or delivery location). Thus, the intersection of tours defined for two different vehicles will be an empty set. Equation (4) enforces the constraint that the V tours, each traveled by a different vehicle, will cover all the 2n locations in set N and therefore all the transport requests will be served. Thus, V vehicles will cover n pickup locations and n delivery locations. The complete route plan S for all the V vehicles is represented as a collection of V tours such that S={S1, S2, . . . , SV}.

$$S = \{ {S}_{1} , … , {S}_{V} \} . \qquad ( 5 )$$

$${W}_{k} = \{ {w}_{{i}_{1}} , {w}_{{i}_{2}} , … , {w}_{{i}_{τ}} \} , and \qquad ( 6 )$$

$${ω}_{t} = {\sum }_{l = 1}^{t} {w}_{{i}_{l}} \qquad ( 7 )$$

Each transport request i is characterized by a load volume wi>0. We assign the pickup point i with a positive weight wi and the corresponding delivery point with a negative weight wi+n. For the vehicle k, we formulate an ordered sequence of weights Wk (6) that signifies the order of picked or delivered load at each time step. Precisely, if wit>0 then vehicle k picks up the load wit from node it at time step t; if wit<0 then vehicle k drops the load wit to node it at time step t. We define the cumulative weight at each time step t=1, 2, . . . , τ as ωt (7).

At each time step t, the cumulative weight must not exceed the total capacity Ck of the vehicle k. This is the capacity constraint and is expressed as:

$${max}_{t} \{ {ω}_{t} \} ⩽ {C}_{k} for all k = 1 , … , V . \qquad ( 8 )$$

This precisely means that the maximum load carried by a vehicle across any time step within the route must be less than or equal to the maximum capacity of the corresponding vehicle. Since we enforce the capacity constraint and the precedence constraint, we define the set of feasible solutions as the set of tours that satisfy the (1) -(4) and (8). We refer to the set of feasible solutions as solution space S and all the elements of solution space are valid route plans.

$$S := \{ S \vert S obeys ( 1 ) - ( 5 ) and ( 8 ) \} . \qquad ( 9 )$$

$${d}^{( k )} = {\sum }_{t = 1}^{τ - 1} {d}_{{i}_{t} , {i}_{t + 1}} , and$$

$$d ( S ) = {\sum }_{k = 1}^{V} {d}^{( k )} \qquad ( 10 )$$

$$min d ( S ) subject to S ∈ 𝒮 . \qquad ( 11 )$$

For the valid route plan, S∈S, we compute the distance d(k) traveled by each vehicle k in a route Sk and calculate the total distance d(S) traveled by all the V vehicles in route plan S. To find the optimal route plan Sopt the objective is to minimize the total distance over the solution space S. The solution to the optimization problem (11) is to find Sopt and corresponds to the global minimum of d(S). The pickup and delivery problem with capacity constraints as we have defined is a generalization of the Traveling Salesman Problem and finding the optimal solution is NP-hard. We have invented a system of procedures that finds an approximate solution Sapp such that d(Sapp) is close to d(Sopt).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore. while the embodiments herein have been described in terms of preferred embodiments, those skilled in the art will recognize that the embodiments herein can be practiced with modifications.

The embodiments herein provide system and method that facilitate achieving an optimal route plan for pickup and delivery services. By achieving the optimization, the system and method of the embodiments herein enable achieving a reduction in the distance traveled for serving customer requests. The reduction in distance traveled results in reduction of overall distribution costs, total time, and fuel consumption. The system and the method of the embodiments herein enable handling of more customer requests without upfront investment in the vehicle fleet when compared to conventional systems. The embodiments herein also render the fleet management to be more efficient with a reduced number of dispatchers when compared to conventional systems. Moreover, the embodiments herein provide results in a reliable decision-support system for pickup and delivery vehicle routing with quantitative information.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

What is claimed is:

1. A computer implemented method comprising instructions stored on a non-transitory computer readable storage medium and executed on a hardware processor provided in a computing device for a combinatorial optimization of vehicle routing using one or more algorithms or applications, and the method comprising steps of:
receiving a set of transport request as input from a supplier to a customer, wherein the transport request includes pickup and delivery points and corresponding load volumes need to be transported from the pickup to the delivery points;
identifying the pickup and the delivery points as per corresponding geographical locations, wherein the geographical locations include respective latitude and longitude co-ordinates of the pickup and delivery points;
computing distance matrix for all the geographical locations for the given set of transport request;
characterizing the transport request received from the supplier to the customer; and
generating near-optimal route plan Sₐₚₚ and total distance travelled d(Sₐₚₚ) by a vehicle as output for the given set of transport requests based on a simulated annealing metaheuristic algorithm, wherein the near-optimal route plan is generated for the route plan which meets precedence and capacity constraint.

2. The method for combinatorial optimization of vehicle routing according to claim 1, wherein the characterizing the transport request is carried out by generating a random tour S, wherein the random tour S is the element of solution space S (S∈S) and the near-optimal route plan Sₐₚₚ is set to random tour S (Sₐₚₚ=S), total distance travelled d(Sₐₚₚ) to total distance d(S) travelled by all the vehicles V in the random tour S (d(Sₐₚₚ)=d(S)) and T=Tᵢₙ.

3. The method for combinatorial optimization of vehicle routing according to claim 2, wherein from the random tour S a new state S′ is generated by a rule, wherein the rule includes moving a random customer from one vehicle to another randomly chosen vehicle and assigning the new state S′ according to S:=S′.

4. The method for combinatorial optimization of vehicle routing according to claim 2, wherein the solution space S is the set of feasible or possible valid route plans.

5. The method for combinatorial optimization of vehicle routing according to claim 1, wherein the precedence constraint is defined such that the order of pickup location does precede the delivery location in route enumeration.

6. The method for combinatorial optimization of vehicle routing according to claim 1, wherein the capacity constraint of a vehicle is defined such that the total volume of load transported by a vehicle for a given set of delivery services does not exceed the vehicle maximum capacity.

7. The method for combinatorial optimization of vehicle routing according to claim 1, wherein the transport request is either static or dynamic input.

8. The method for combinatorial optimization of vehicle routing according to claim 7, wherein the dynamically changing transport request as inputs include deletion of pickup and delivery locations or addition of pickup and delivery locations towards the existing set of pickup and delivery locations.

9. The method for combinatorial optimization of vehicle routing according to claim 8, wherein the deletion of pickup and delivery locations is achieved by finding a vehicle V assigned to a customer who wants to delete the transport request, deleting the corresponding pickup and delivery locations of the vehicle V and rerouting the existing pickup and delivery locations using the simulated annealing metaheuristic algorithm.

10. The method for combinatorial optimization of vehicle routing according to claim 8, wherein the addition of pickup and delivery location is achieved by adding a new transport request of addition to the existing set of pickup and delivery locations and applying simulated annealing metaheuristic algorithm.

11. A computing system for combinatorial optimization of vehicle routing using one or algorithms or applications by executing instructions stored on a non-transitory computer readable storage medium and executed on a hardware processor provided in the computing system, and the system comprises:
a transport request collection module configured to capture plurality of data and to route the captured plurality of data; wherein the plurality of data includes transport request from a supplier to a customer, load volume, pickup, and delivery locations;
a transport route determination module configured to receive the plurality of captured data from the transport request collection module;
a geographical index computation module provided in the transport route determination module and configured to identify the pickup and the delivery locations as per corresponding geographical locations of the transport request and to compute distance matrix for all the geographical locations in the given set of transport request;
a route plan generator module provided in the transport route determination module and configured to generate all possible routes for the given set of transport requests;
a route optimization module provided in the transport route determination module is configured to optimize the route plans for the collection of routes generated by the route plan generator module of the transport route determination module based on simulated annealing metaheuristic algorithm;
a route constraint evaluator module provided in the transport route determination module and configured to evaluate precedence constraint, wherein the precedence constraint is defined such that the order of pickup location does precede the delivery location in route enumeration;
a vehicle constraint evaluator module provided in the transport route determination module and configured to evaluate capacity constraint, wherein the capacity constraint is defined as the total volume of load transported by a vehicle for a given set of delivery services does not exceed the vehicle maximum load capacity;
a route plan response module configured to receive the optimized route plan for the set of transport request from the transport route determination module and provides near-optimal route plan and total distance travelled by the vehicle based on simulated annealing metaheuristic algorithm, wherein the near-optimal route plan generated satisfies the precedence constraint and capacity constraint.

12. The system for combinatorial optimization of vehicle routing according to claim 11, wherein the geographical locations include respective latitude and longitude co-ordinates of the pickup and delivery points.
